(19) United States
(12) Patent Application Publication
(10) Pub. No.: US 2019/0181451 A1
(43) Pub. Date: Jun. 13, 2019

(54) SILICON-BASED COMPOSITE WITH THREE DIMENSIONAL BINDING NETWORK FOR LITHIUM ION BATTERIES

(71) Applicant: Robert Bosch GmbH, Stuttgart (DE)

(72) Inventors: Jun Yang, Shanghai (CN); Yitian Bie, Shanghai (CN); Jingjun Zhang, Shanghai (CN); Yuqian Dou, Shanghai (CN); Rongrong Jiang, Shanghai (CN); Lei Wang, Shanghai (CN); Qiang Lu, Shanghai (CN); Xiaogang Hao, Shanghai (CN)

(73) Assignee: Robert Bosch GmbH, Stuttgart (DE)

(21) Appl. No.: 16/310,601

(22) PCT Filed: Jun. 15, 2016
(86) PCT No.: PCT/CN2016/085899

§ 371 Date: Dec. 17, 2018

(51) Int. Cl. H01M 4/62; H01M 4/134; H01M 4/1395; H01M 4/36; H01M 4/38; H01M 10/0525; H01M 10/44; H01M 10/058; H01M 4/04

(52) U.S. Cl. CPC H01M 4/622; H01M 4/134; H01M 4/1395; H01M 4/366; H01M 4/386; H01M 2010/4292; H01M 10/446; H01M 10/058; H01M 4/0447; H01M 4/625; H01M 10/0525

(57) ABSTRACT

A silicon-based composite with three dimensional binding network and enhanced interaction between binder and silicon-based material comprises silicon-based material, treatment material, a binder containing carboxyl groups and conductive carbon, wherein the treatment material is selected from the group consisting of polydopamine or silane coupling agent with amine and/or imine groups; as well as relates to an electrode material and a lithium-ion battery comprising said silicon-based composite, and a process for preparing said silicon-based composite.

### TECHNICAL FIELD

The present invention relates to a silicon-based composite with three dimensional binding network and enhanced interaction between binder and silicon-based material for lithium ion batteries; as well as an electrode material and a lithium ion battery comprising said silicon-based composite.

### BACKGROUND ART

With the rapid development and popularization of portable electronic devices and electronic vehicles, the demand for lithium ion batteries with increased energy and powder density becomes more and more urgent. Silicon is a promising alternative electrode material for lithium ion batteries owning to its large theoretical capacity (Li₁₅Si₄, 3579 mAh g⁻¹) and moderate operating voltage (0.4 V vs Li/Li⁺).

However, there are many challenges for the practical application of silicon, for example, during lithiation/delithiation process, silicon undergoes dramatic expansion and contraction, which would cause many cracks in both Si-based active materials and electrode. These cracks lead to loss of electronic conductivity. In addition, the cracks also results in continuous growth of solid-electrolyte interphase (SEI), which results in loss of ionic conductivity and consumption of Li, and thus leads to fast capacity decay. Great efforts have been paid in designing Si-based materials with nano or porous structure to mitigate the negative volume effect and improve the electrochemical performance.

Beyond the active materials, recent studies have shown that the binder network also plays a critical role in maintaining the electrode integrity during volume change in the electrode and is associated with many important electrochemical properties, especially the cycling performance.

Among all kinds of binders, binders comprising carboxyl groups, such as polyacrylic acid (PAA), carboxymethyl cellulose (CMC), sodium alginate (SA) are more used since the carboxyl groups on the binders can form hydrogen bonds with silicon. Nevertheless, the hydrogen bonds formed by carboxyl groups are still not strong enough to endure the extent volume change of silicon, especially in high mass loading situation. Besides, the binding network formed by above linear binder is also not strong enough to maintain the electrode integrity during long cyling. There are needs to make further modification to ameliorate the binder.

On the other hand, in the effort to design a high-power battery, the reduction of active material particle size to nano-scale can help shorten the diffusion length of charge carriers, enhance the Li-ion diffusion coefficient, and therefore achieve faster reaction kinetics. However, nano-sized active materials have a large surface area, which results in a high irreversible capacity loss due to the formation of a solid electrode interface (SEI). For silicon oxide based anode, the irreversible reaction during the first lithiation also leads to a large irreversible capacity loss in initial cycle. This irreversible capacity loss consumes Li in the cathode, which decreases the capacity of the full cell.

Even worse, for Si-based anode, repeated volume change during cycling reveals more and more fresh surface on the anode, which leads to continuous growth of SEI. And the continuous growth of SEI continuously consumes Li in the cathode, which results in capacity decay for the full cell.

In order to provide more lithium ions to compensate for an SEI or other lithium consumption during the formation, additional or supplementary Li may be provided by the prelithiation of the anode. If the prelithiation of the anode is conducted, the irreversible capacity loss could be compensated in advance instead of Li consumption from the cathode. This results in higher efficiency and capacity of the cell.

However, a pre-lithiation degree of exact compensation for the irreversible loss of lithium from the anode doesn't help to solve the problem of Li consumption from the cathode during cycling. Therefore, in this case, the cycling performance will not be improved. To compensate for the loss of lithium from the cathode during cycling, an over-prelithiation is conducted in the present invention.

### SUMMARY OF INVENTION

It is therefore an object of the present invention to provide further modification to the binder used in a silicon-based composite for lithium ion batteries. According to the present invention, three dimensional binding network and enhanced interaction between binder and silicon-based material can be established in the silicon-based composite by further incorporating treatment material into the composite, wherein said treatment material can be selected from the group consisting of polydopamine (briefed as “PD” hereinafter) and silane coupling agent with amine and/or imine groups.

According to the present invention, an enhanced interaction between a binder and silicon-based material can be realized by either stronger hydrogen bonds formed between catechol groups in PD and Si—OH, or covalent bonds formed between the hydrolysis ends in the silane coupling agent and Si—OH. Moreover, PD or silane coupling agent with amine and/or imine groups is linked to the binder through covalent bond formed by amine/imine group in PD or in silane coupling agent with the carboxyl group contained in the binder.

Accordingly, the present invention provides a silicon-based composite with three dimensional binding network and enhanced interaction between binder and silicon-based material for lithium ion batteries, said composite comprises silicon-based material, treatment material, a binder which contains carboxyl groups, and conductive carbon, wherein the treatment material is selected from the group consisting of polydopamine (PD) and silane coupling agent with amine and/or imine groups.

According to the present invention, a process I for preparing the above silicon-based composite, wherein the treatment material is PD, is provided, which comprises the steps of dispersing silicon-based material in a buffer solution containing dopamine, initiating in-situ polymerization of dopamine on the surface of the silicon-based material by air oxidization, collecting the silicon-based material coated by polydopamine, and crosslinking the polydopamine to a binder which contains carboxyl groups.

Alternatively, according to the present invention, a process II for preparing the above silicon-based composite, wherein the treatment material is silane coupling agent with amine and/or imine groups, is provided, which comprises the steps of adding silane coupling agent with amine and/or imine groups into a slurry comprising silicon-based material, a binder which contains carboxyl groups and conductive carbon during stirring.

The present invention further provides an electrode material, which comprises the silicon-based composite according to the present invention, or the silicon-based composite prepared by the process I or by the process II.

The present invention further provides a lithium ion battery, which comprises the silicon-based composite according to the present invention, or the silicon-based composite prepared by the process I or by the process II.

### BRIEF DESCRIPTION OF DRAWINGS

FIG. 1 is a schematic illustration of the three dimensional binding network and the corresponding structural formula when polydopamine is added to the silicon-based composite.

FIG. 2 is Transmission Electron Microscopy (TEM) images showing (a) pristine Si particles, (b) Si@PD particles prepared in Example 1 and (c) in Comparative Examples 1b.

FIG. 3 is a schematic illustration of the three dimensional binding network and the corresponding structural formula when silane coupling agent with amine and/or imine groups is added to the silicon-based composite.

FIG. 4 is Fourier transform infrared (FT-IR) spectra of (a) Si electrode prepared with addition of 1 wt % silane coupling agent KH550 obtained in Example 6, (b) pristine Si, and (c) PAA binder.

FIG. 5 is a plot showing the cycling performance of (a) the Si electrodes prepared in Example 1, (b) Comparative Example 1a and (c) 1b with a low mass loading of active materials.

FIG. 6 is a plot showing the cycling performance of (a) the Si electrodes prepared in Example 2 and (b) Comparative Example 2 with a high mass loading of active materials.

FIG. 7 is a plot showing the cycling performance of the Si electrodes prepared in Comparative Example 1a, modified Si electrode prepared in Examples 3-6 and Comparative Example 3, with a low mass loading of active materials.

FIG. 8 is a plot showing the cycling performance of (a) the modified Si electrode prepared in Example 7 and (b) Comparative Example 2, with a high mass loading of active materials.

FIG. 9 is a plot showing the cycling performance of the Si electrodes prepared in Examples 4-6 and Comparative Example 4.

FIG. 10 shows the cycling performances of the full cells of Example P1-E1.

FIG. 11 shows the normalized energy densities of the full cells of Example P1-E1.

FIG. 12 shows the cycling performances of the full cells of Example P1-E2.

FIG. 13 shows the normalized energy densities of the full cells of Example P1-E2.

FIG. 14 shows the cycling performances of the full cells of Example P1-E3 with the prelithiation degrees ε of a) 0 and b) 22%.

FIG. 15 shows the discharge/charge curve of the cell of Comparative Example P2-CE1, wherein “1”, “4”, “50” and “100” stand for the 1^{st}, 4^{th}, 50^{th} and 100^{th} cycle respectively.

FIG. 16 shows the discharge/charge curve of the cell of Example P2-E1, wherein “1”, “4”, “50” and “100” stand for the 1^{st}, 4^{th}, 50^{th} and 100^{th} cycle respectively.

FIG. 17 shows the cycling performances of the cells of a) Comparative Example P2-CE1 (dashed line) and b) Example P2-E1 (solid line).

FIG. 18 shows the average charge voltage a) and the average discharge voltage b) of the cell of Comparative Example P2-CE1.

FIG. 19 shows the average charge voltage a) and the average discharge voltage b) of the cell of Example P2-E1.

### DETAILED DESCRIPTION OF PREFERRED EMBODIMENTS

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

According to the present invention, three dimensional binding network can be established in the silicon-based composite used in lithium ion batteries by incorporating treatment material into the composite, wherein the treatment material is selected from the group consisting of polydopamine (PD) and silane coupling agent with amine and/or imine groups.

In the context of the present invention, said silicon-based material can be any suitable forms of silicon-based material as long as its surface could carry hydroxyl group, and the examples thereof can be silicon particles, silicon films and so on. For example, nano-silicon particles are used in the examples of the present invention.

In the context of the present invention, the binder which contains carboxyl groups can be any suitable binder as long as it carries carboxyl groups. The preferable binder is selected from the group consisting of polyacrylic acid (hereinafter briefed as “PAA”), carboxymethyl cellulose (hereinafter briefed as “CMC”), sodium alginate (hereinafter briefed as “SA”), copolymers thereof and combinations thereof.

In the context of the present invention, the silane coupling agent with amine and/or imine groups can be any suitable silane coupling agent as long as it carries amine groups, or imine groups, or both amine and imine groups.

In the context of the present invention, the abbreviated expression “Si@PD” is used to indicate the Si-based material coated by PD, which can be clearly understood by a person skilled in the art.

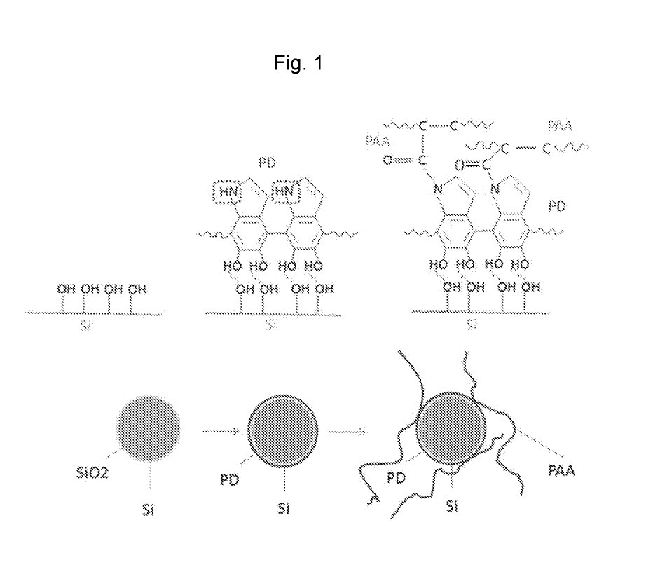

FIG. 1 shows a schematic illustration of the three dimensional binding network after PD is added to the silicon-based composite. As can be seen from FIG. 1, the silicon-based material is nano silicon particles that are covered with a thin layer of SiO₂ generated by air oxidation. If without PD coating, the interaction between silicon and binder (herein PAA) is by hydrogen bonds formed by carboxyl group in binder and Si—OH on Si surface. With PD coating, the interaction is changed to hydrogen bonds formed by catechol groups on PD and Si—OH on the surface of Si particles. These hydrogen bonds are stronger than previous hydrogen bonds formed between carboxyl group in PAA and Si—OH. Then, the imine groups of PD react with carboxyl groups of the binder, for example PAA, by condensation reaction, thus forming a three dimensional binding network.

In one embodiment of the present invention, a silicon-based composite with three dimensional binding network comprises silicon-based material, polydopamine coating on said silicon-base material, a binder which contains carboxyl groups, and conductive carbon. In a preferable embodiment of the present invention, the average thickness of the polydopamine coating layer on said silicon-based material is in the range of 0.5 to 2.5 nm, preferably 1 to 2 nm. Within the above range, the content of PD corresponds to about 5-8 wt % based on the weight of Si-based material.

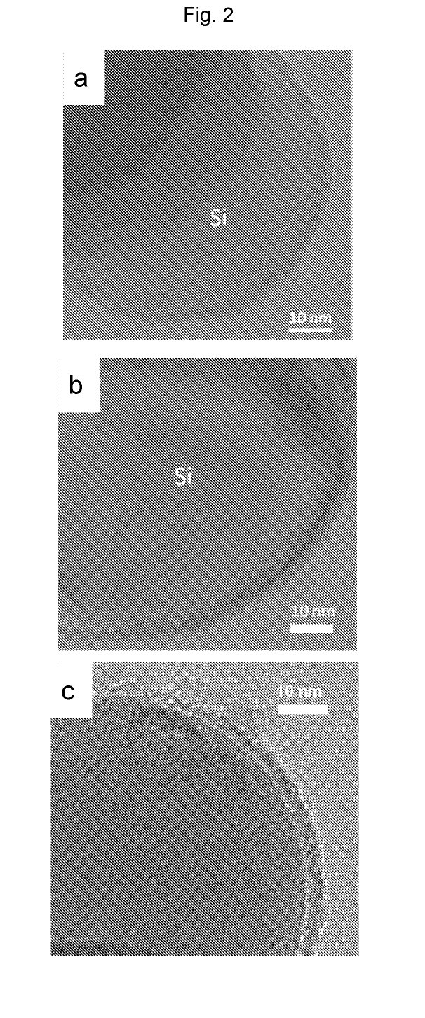

FIG. 2 is Transmission Electron Microscopy (TEM) images of pristine Si particles and Si@PD particles. In FIG. 2a, there is a thin layer of SiO₂ (ca. 3 nm) on the surface of pristine nano Si. After PD coating, the outer layer thickness increases to ca. 5 nm as shown in FIG. 2b, which indicates that the particles of silicon are uniformly coated with a layer of PD with thickness about 1-2 nm. FIG. 2c corresponds to Comparative Example 1b, wherein the thickness of a layer of PD is about 3 nm.

The preparation process I for the above silicon-based composite with three dimensional binding network comprises: (1) dispersing silicon-based material in a buffer solution containing dopamine, (2) initiating in-situ polymerization of dopamine on the surface of the silicon-based material by air oxidization, (3) collecting the silicon-based material coated by polydopamine, and (4) crosslinking the polydopamine to a binder which contains carboxyl groups.

Alternatively, the present invention provides a silicon-based composite with three dimensional binding network, and said composite comprises silicon-based material, silane coupling agent with amine and/or imine groups, a binder containing carboxyl groups, and conductive carbon. In a preferable embodiment of the present invention, the amount of the silane coupling agent is from 0.01-2.5 wt %, preferably 0.05-2.0 wt %, more preferably 0.1-2.0 wt %, and much more preferably 0.1-1.0% based on the weight of the silicon-based material.

In an embodiment of the present invention, the examples of silane coupling agent with amine and/or imine groups can be suitable silane coupling agent that carries amine groups, or imine groups, or both amine and imine groups, and the preferable examples thereof are one or more selected from the group consisting of γ-aminopropyl methyl diethoxy silane (NH₂C₃H₆CH₃Si(OC₂H₅)₂), γ-aminopropyl methyl dimethoxy silane (NH₂C₃H₆CH₃Si(OCH₃)₂), γ-aminopropyl triethoxy silane (NH₂C₃H₆Si(OC₂H₅)₃), γ-aminopropyl trimethoxy silane (NH₂C₃H₆Si(OCH₃)₃), N-(β-aminoethyl)-γ-aminopropyl trimethoxy silane (NH₂C₂H₄NHC₃H₆Si(OCH₃)₃), N-(β-aminoethyl)-γ-aminopropyl triethoxy silane (NH₂C₂H₄NHC₃H₆Si(OC₂H₅)₃, N-(β-aminoethyl)-γ-aminopropyl methyl dimethoxysilane (NH₂C₂H₄NHC₃H₆SiCH₃(OCH₃)₂), N,N-(aminopropyltriethoxy) silane (HN[(CH₂)₃Si(OC₂H₅)₃]₂), γ-trimethoxysilyl propyl diethylenetriamine (NH₂C₂H₄NHC₂H₄NHC₃H₆Si(OCH₃)₃), γ-divinyltriamine propymethyldimethoxyl silane (NH₂C₂H₄NHC₂H₄NHC₃H₆CH₃Si(OCH₃)₂), bis-γ-trimethoxysilypropyl amine, aminoneohexyltromethoxysilane, and aminoneohexylmethydimethoxysilane.

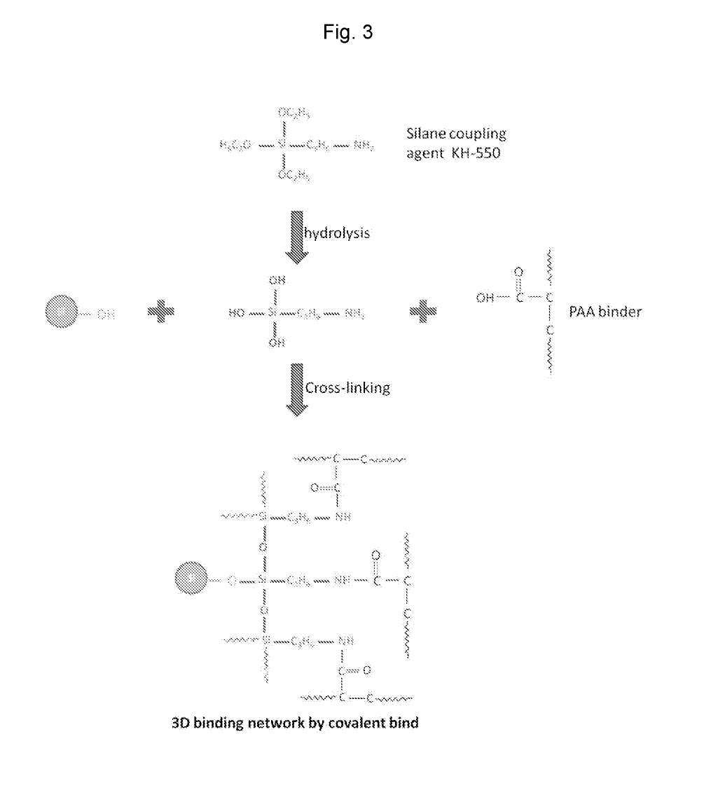

FIG. 3 is a schematic illustration of the three dimensional binding network after silane coupling agent with amine and/or imine groups is added to the silicon-based composite. The exemplified silane coupling agent KH550 contains three hydrolytic ends (—OC₂H₅) and one none-hydrolytic end (—C₃H₆—NH₂). During slurry preparation and further vacuum drying, the hydrolytic ends of silane coupling agent hydrolyze to form covalent bonds with Si—OH on silicon surface or hydrolytic ends of other silane coupling agent; on the other hand, the —NH₂ group in silane coupling agent react with —COOH group in the binder which contains carboxyl group; thus forming a strong three-dimensional binding network.

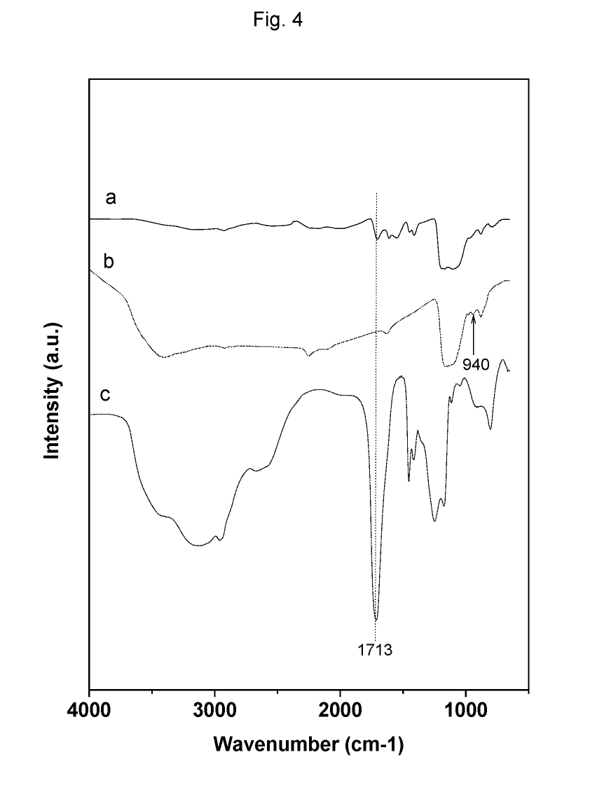

FT-IR spectra in FIG. 4 show the evidence of formation of three-dimensional network connected by covalent bonds. The peak at 940 cm⁻¹ in nano Si particles is attributed to vibration of silanol O—H group on the surface of nano Si. This peak almost disappears on Si electrode. This is due to the condensation of silanol groups on surface of Si with hydrolytic ends of KH550. The peaks at 1713 cm⁻¹ in PAA, which corresponds to stretching vibration of C═O in carboxyl group, blue shifts to 1700 cm⁻¹ in Si electrode due to the formation of amide. This result provides a proof of cross-linking reaction between —COOH in PAA binder and —NH₂ group in KH550.

The preparation process II for the above silicon-based composite with three dimensional binding network comprises: adding silane coupling agent with amine and/or imine groups into a slurry comprising silicon-based material, a binder which contains carboxyl groups and conductive carbon during stirring.

Accordingly, the present invention provides a silicon-based composite comprising three dimensional binding network for lithium ion batteries.

The present invention further relates to an electrode material, which comprises the silicon-based composite according to the present invention, or the silicon-based composite prepared by the process I or by the process II.

The present invention further relates to a lithium-ion battery, which comprises the silicon-based composite according to the present invention, or the silicon-based composite prepared by the process I or by the process II.

In general, when the cathode efficiency is higher than the anode efficiency, a prelithiation can effectively increase the cell capacity via increasing the initial Coulombic efficiency. In this case, maximum energy density can be reached. For a cell, in which the loss of lithium during cycling may occur, prelithiation can also improve the cycling performance when an over-prelithiation is applied. The over-prelithiation provides a reservoir of lithium in the whole electrochemical system and the extra lithium in the anode compensates the possible lithium consumption from the cathode during cycling.

In principle, the higher prelithiation degree, the better cycling performance could be achieved. However, a higher prelithiation degree involves a much larger anode. Therefore, the cell energy density will decrease due to the increased weight and volume of the anode. Therefore, the prelithiation degree should be carefully controlled to balance the cycling performance and the energy density.

The present invention, according to one aspect, relates to a lithium-ion battery comprising a cathode, an electrolyte, and an anode, wherein the anode comprises the electrode material according to the present invention, and the initial surface capacity a of the cathode and the initial surface capacity b of the anode satisfy the relation formulae

1<(b·(1−ε)/a)≤1.2 (I),

0<ε≤((a·η₁)/0.6−(a−b·(1−η₂)))/b (II),

where
ε is the prelithiation degree of the anode,
η₁ is the initial coulombic efficiency of the cathode, and
η₂ is the initial coulombic efficiency of the anode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

According to the present invention, the term “prelithiation degree” ε of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

In accordance with an embodiment of the lithium-ion battery according to the present invention, the initial surface capacity a of the cathode and the initial surface capacity b of the anode satisfy the relation formulae

1.05≤(b·(1−ε)/a)≤1.15 (Ia),

preferably 1.08≤(b·(1−ε)/a)≤1.12 (Ib).

In accordance with another embodiment of the lithium-ion battery according to the present invention, the prelithiation degree of the anode can be defined as

ε=((a·η₁)/c−(a−b·(1−η₂)))/b (III),

0.6≤c<1 (IV),

preferably 0.7≤c<1 (IVa),

more preferably 0.7≤c≤0.9 (IVb),

particular preferably 0.75≤c≤0.85 (IVc),

where
c is the depth of discharge (DoD) of the anode.

In particular, ε=(b*(1−η₂)−a·(1−η₁))/b, when c=1.

In accordance with another embodiment of the lithium-ion battery according to the present invention, the active material of the anode can be selected from the group consisting of carbon, silicon, silicon intermetallic compound, silicon oxide, silicon alloy and mixtures thereof.

In accordance with another embodiment of the lithium-ion battery according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

The present invention, according to another aspect, relates to a method for producing a lithium-ion battery comprising a cathode, an electrolyte, and an anode, wherein the anode comprises the electrode material according to the present invention, and said method includes the following steps:
1) prelithiating the active material of the anode or the anode to a prelithiation degree ε, and
2) assembling the anode and the cathode to obtain said lithium-ion battery, characterized in that the initial surface capacity a of the cathode, the initial surface capacity b of the anode, and the prelithiation degree ε satisfy the relation formulae

1<(b·(1−ε)/a)≤1.2 (I),

0<ε≤((a·η₁)/0.6−(a−b·(1−η₂)))/b (II),

where
ε is the prelithiation degree of the anode,
η₁ is the initial coulombic efficiency of the cathode, and
η₂ is the initial coulombic efficiency of the anode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

According to the present invention, the term “prelithiation degree” ε of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

The prelithiation process is not particularly limited. The lithiation of the anode active material substrate can be carried out for example in several different ways. A physical process includes deposition of a lithium coating layer on the surface of the anode active material substrate such as silicon particles, thermally induced diffusion of lithium into the substrate such as silicon particles, or spray of stabilized Li powder onto the anode tape. An electrochemical process includes using silicon particles and a lithium metal plate as the electrodes, and applying an electrochemical potential so as to intercalate Li⁺ ions into the bulk of the silicon particles. An alternative electrochemical process includes assembling a half cell with silicon particles and Li metal foil electrodes, charging the half cell, and disassembling the half cell to obtain lithiated silicon particles.

In accordance with an embodiment of the method according to the present invention, the initial surface capacity a of the cathode and the initial surface capacity b of the anode satisfy the relation formulae

1.05≤(b·(1−ε)/a)≤1.15 (Ia),

preferably 1.08≤(b·(1−ε)/a)≤1.12 (Ib).

In accordance with another embodiment of the method according to the present invention, the prelithiation degree of the anode can be defined as

ε=((a·η₁)/c−(a−b·(1−η₂)))/b (III),

0.6≤c<1 (IV),

preferably 0.7≤c<1 (IVa),

more preferably 0.7≤c≤0.9 (IVb),

particular preferably 0.75≤c≤0.85 (IVc),

where
c is the depth of discharge (DoD) of the anode.

In particular, c=(b·(1−η₂)−a·(1−η₁))/b, when c=1.

In accordance with another embodiment of the method according to the present invention, the active material of the anode can be selected from the group consisting of carbon, silicon, silicon intermetallic compound, silicon oxide, silicon alloy and mixtures thereof.

In accordance with another embodiment of the method according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

Prior art prelithiation methods often involve a treatment of coated anode tape. This could be an electrochemical process, or physical contact of the anode with stabilized lithium metal powder. However, these prelithiation procedure requires additional steps to the current battery production method. Furthermore, due to the highly active nature of the prelithiated anode, the subsequent battery production procedure requires an environment with well-controlled humidity, which results in an increased cost for the cell production.

The present invention provides an alternative method of in-situ prelithiation. The lithium source for prelithaition comes from the cathode. During the first formation cycle, by increasing the cut-off voltage of the full cell, additional amount of lithium is extracted from the cathode; by controlling the discharge capacity, the additional lithium extracted from the cathode is stored at the anode, and this is ensured in the following cycles by maintaining the upper cut-off voltage the same as in the first cycle.

The present invention, according to another aspect, relates to a lithium-ion battery comprising a cathode, an electrolyte, and an anode, characterized in that the anode comprises the electrode material according to the present invention, and said lithium-ion battery is subjected to a formation process, wherein said formation process includes an initial formation cycle comprising the following steps:
a) charging the battery to a cut off voltage V_{off} which is greater than the nominal charge cut off voltage of the battery, and
b) discharging the battery to the nominal discharge cut off voltage of the battery.

In the context of the present invention, the term “formation process” means the initial one or more charging/discharging cycles of the lithium-ion battery for example at 0.1 C, once the lithium-ion battery is assembled. During this process, a stable solid-electrolyte-inter-phase (SEI) layer can be formed at the anode.

In accordance with an embodiment of the formation process according to the present invention, in step a) the battery can be charged to a cut off voltage which is up to 0.8 V greater than the nominal charge cut off voltage of the battery, preferably 0.1˜0.5 V greater than the nominal charge cut off voltage of the battery, more preferably 0.2˜0.4 V greater than the nominal charge cut off voltage of the battery, particular preferably about 0.3 V greater than the nominal charge cut off voltage of the battery.

A lithium-ion battery with the typical cathode materials of cobalt, nickel, manganese and aluminum typically charges to 4.20V±50 mV as the nominal charge cut off voltage. Some nickel-based batteries charge to 4.10V±50 mV.

In accordance with another embodiment of the formation process according to the present invention, the nominal charge cut off voltage of the battery can be about 4.2 V±50 mV, and the nominal discharge cut off voltage of the battery can be about 2.5 V±50 mV.

In accordance with another embodiment of the formation process according to the present invention, the Coulombic efficiency of the cathode in the initial formation cycle can be 40%˜80%, preferably 50%˜70%.

In accordance with another embodiment of the formation process according to the present invention, said formation process further includes one or two or more formation cycles, which are carried out in the same way as the initial formation cycle.

For the traditional lithium-ion batteries, when the battery is charged to a cut off voltage greater than the nominal charge cut off voltage, metallic lithium will be plated on the anode, the cathode material becomes an oxidizing agent, produces carbon dioxide (CO₂), and increases the battery pressure.

In case of a preferred lithium-ion battery defined below according to the present invention, when the battery is charged to a cut off voltage greater than the nominal charge cut off voltage, additional Li⁺ ions can be intercalated into the anode having additional capacity, instead of being plated on the anode.

In case of another preferred lithium-ion battery defined below according to the present invention, in which the electrolyte comprises one or more fluorinated carbonate compounds as a nonaqueous organic solvent, the electrochemical window of the electrolyte can be broadened, and the safety of the battery can still be ensured at a charge cut off voltage of 5V or even higher.

In order to implement the present invention, an additional cathode capacity can preferably be supplemented to the nominal initial surface capacity of the cathode.

In the context of the present invention, the term “nominal initial surface capacity” a of the cathode means the nominally designed initial surface capacity of the cathode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

In accordance with an embodiment of the lithium-ion battery according to the present invention, the relative increment r of the initial surface capacity of the cathode over the nominal initial surface capacity a of the cathode and the cut off voltage V_{off} satisfy the following linear equation with a tolerance of ±5%, ±10%, or ±20%

r=0.75V_{off}−3.134 (V).

In accordance with another embodiment of the lithium-ion battery according to the present invention, the relative increment r of the initial surface capacity of the cathode over the nominal initial surface capacity a of the cathode and the cut off voltage V_{off} satisfy the following quadratic equation with a tolerance of ±5%, ±10%, or ±20%

r=−0.7857V_{off}²+7.6643V_{off}−18.33 (Va).

In accordance with another embodiment of the lithium-ion battery according to the present invention, the nominal initial surface capacity a of the cathode and the initial surface capacity b of the anode satisfy the relation formulae

1<b·η₂/(a·(1+r)−b·(1−η₂))−ε≤1.2 (I′),

preferably 1.05≤b·η₂/(a*(1+r)−b·(1−η₂))−ε≤1.15 (Ia′),

more preferably 1.08≤b·η₂/(a·(1+r)−b*(1−η₂))−ε≤1.12 (Ib′),

0<ε≤((a·η₁)/0.6−(a−b·(1−η₂)))/b (II),

where
ε is the prelithiation degree of the anode, and
η₂ is the initial coulombic efficiency of the anode.

According to the present invention, the term “prelithiation degree” ε of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

In accordance with another embodiment of the lithium-ion battery according to the present invention, the prelithiation degree of the anode can be defined as

ε=((a·η₁)/c−(a−b·(1−η₂)))/b (III),

0.6≤c<1 (IV),

preferably 0.7≤c<1 (IVa),

more preferably 0.7≤c≤0.9 (IVb),

particular preferably 0.75≤c≤0.85 (IVc),

where
η₁ is the initial coulombic efficiency of the cathode, and
c is the depth of discharge (DoD) of the anode.

In particular, c=(b·(1−η₂)−a·(1−η₁))/b, when c=1.

In accordance with another embodiment of the lithium-ion battery according to the present invention, the electrolyte comprises one or more fluorinated carbonate compounds, preferably fluorinated cyclic or acyclic carbonate compounds, as a nonaqueous organic solvent.

In accordance with another embodiment of the lithium-ion battery according to the present invention, the fluorinated carbonate compounds can be selected from the group consisting of fluorinated ethylene carbonate, fluorinated propylene carbonate, fluorinated dimethyl carbonate, fluorinated methyl ethyl carbonate, and fluorinated diethyl carbonate, in which the “fluorinated” carbonate compounds can be understood as “monofluorinated”, “difluorinated”, “trifluorinated”, “tetrafluorinated”, and “perfluorinated” carbonate compounds.

In accordance with another embodiment of the lithium-ion battery according to the present invention, the fluorinated carbonate compounds can be selected from the group consisting of monofluoroethylene carbonate, 4,4-difluoro ethylene carbonate, 4,5-difluoro ethylene carbonate, 4,4,5-trifluoroethylene carbonate, 4,4,5,5-tetrafluoroethylene carbonate, 4-fluoro-4-methyl ethylene carbonate, 4,5-difluoro-4-methyl ethylene carbonate, 4-fluoro-5-methyl ethylene carbonate, 4,4-difluoro-5-methyl ethylene carbonate, 4-(fluoromethyl)-ethylene carbonate, 4-(difluoromethyl)-ethylene carbonate, 4-(trifluoromethyl)-ethylene carbonate, 4-(fluoromethyl)-4-fluoro ethylene carbonate, 4-(fluoromethyl)-5-fluoro ethylene carbonate, 4,4,5-trifluoro-5-methyl ethylene carbonate, 4-fluoro-4,5-dimethyl ethylene carbonate, 4,5-difluoro-4,5-dimethyl ethylene carbonate, and 4,4-difluoro-5,5-dimethyl ethylene carbonate.

In accordance with another embodiment of the lithium-ion battery according to the present invention, the content of the fluorinated carbonate compounds can be 10˜100 vol. %, preferably 30˜100 vol. %, more preferably 50˜100 vol. %, particular preferably 80˜100 vol. %, based on the total nonaqueous organic solvent.

In accordance with another embodiment of the lithium-ion battery according to the present invention, the active material of the anode can be selected from the group consisting of carbon, silicon, silicon intermetallic compound, silicon oxide, silicon alloy and mixtures thereof.

In accordance with another embodiment of the lithium-ion battery according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

In accordance with another embodiment of the lithium-ion battery according to the present invention, after being subjected to the formation process, said lithium-ion battery can still be charged to a cut off voltage V_{off}, which is greater than the nominal charge cut off voltage of the battery, and be discharged to the nominal discharge cut off voltage of the battery.

In accordance with another embodiment of the lithium-ion battery according to the present invention, after being subjected to the formation process, said lithium-ion battery can still be charged to a cut off voltage V_{off}, which is up to 0.8 V greater than the nominal charge cut off voltage of the battery, more preferably 0.1˜0.5 V greater than the nominal charge cut off voltage of the battery, particular preferably 0.2˜0.4 V greater than the nominal charge cut off voltage of the battery, especially preferably about 0.3 V greater than the nominal charge cut off voltage of the battery, and be discharged to the nominal discharge cut off voltage of the battery.

The present invention, according to another aspect, relates to a method for producing a lithium-ion battery comprising a cathode, an electrolyte, and an anode, wherein the anode comprises the electrode material according to the present invention, and said method includes the following steps:
1) assembling the anode and the cathode to obtain said lithium-ion battery, and
2) subjecting said lithium-ion battery to a formation process, wherein said formation process includes an initial formation cycle comprising the following steps:
   a) charging the battery to a cut off voltage V_{off} which is greater than the nominal charge cut off voltage of the battery, and
   b) discharging the battery to the nominal discharge cut off voltage of the battery.

In the context of the present invention, the term “formation process” means the initial one or more charging/discharging cycles of the lithium-ion battery for example at 0.1 C, once the lithium-ion battery is assembled. During this process, a stable solid-electrolyte-inter-phase (SEI) layer can be formed at the anode.

In accordance with an embodiment of the formation process according to the present invention, in step a) the battery can be charged to a cut off voltage which is up to 0.8 V greater than the nominal charge cut off voltage of the battery, preferably 0.1˜0.5 V greater than the nominal charge cut off voltage of the battery, more preferably 0.2˜0.4 V greater than the nominal charge cut off voltage of the battery, particular preferably about 0.3 V greater than the nominal charge cut off voltage of the battery.

A lithium-ion battery with the typical cathode materials of cobalt, nickel, manganese and aluminum typically charges to 4.20V±50 mV as the nominal charge cut off voltage. Some nickel-based batteries charge to 4.10V±50 mV.

In accordance with another embodiment of the formation process according to the present invention, the nominal charge cut off voltage of the battery can be about 4.2 V±50 mV, and the nominal discharge cut off voltage of the battery can be about 2.5 V±50 mV.

In accordance with another embodiment of the formation process according to the present invention, the Coulombic efficiency of the cathode in the initial formation cycle can be 40%˜80%, preferably 50%˜70%.

In accordance with another embodiment of the formation process according to the present invention, said formation process further includes one or two or more formation cycles, which are carried out in the same way as the initial formation cycle.

In order to implement the present invention, an additional cathode capacity can preferably be supplemented to the nominal initial surface capacity of the cathode.

In the context of the present invention, the term “nominal initial surface capacity” a of the cathode means the nominally designed initial surface capacity of the cathode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

In accordance with an embodiment of the method according to the present invention, the relative increment r of the initial surface capacity of the cathode over the nominal initial surface capacity a of the cathode and the cut off voltage V_{off} satisfy the following linear equation with a tolerance of ±5%, ±10%, or ±20%

r=0.75V_{off}−3.134 (V).

In accordance with another embodiment of the method according to the present invention, the relative increment r of the initial surface capacity of the cathode over the nominal initial surface capacity a of the cathode and the cut off voltage V_{off} satisfy the following quadratic equation with a tolerance of ±5%, ±10%, or ±20%

r=−0.7857V_{off}²+7.6643V_{off}−18.33 (Va).

In accordance with another embodiment of the method according to the present invention, the nominal initial surface capacity a of the cathode and the initial surface capacity b of the anode satisfy the relation formulae

1<b·η₂/(a·(1+r)−b·(1−η₂))−ε≤1.2 (I′),

preferably 1.05≤b·η₂/(a*(1+r)−b·(1−η₂))−ε≤1.15 (Ia′),

more preferably 1.08≤b·η₂/(a·(1+r)−b*(1−η₂))−ε≤1.12 (Ib′),

0<ε≤((a·η₁)/0.6−(a−b·(1−η₂)))/b (II),

where
ε is the prelithiation degree of the anode, and
η₂ is the initial coulombic efficiency of the anode.

According to the present invention, the term “prelithiation degree” ε of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

In accordance with another embodiment of the method according to the present invention, the prelithiation degree of the anode can be defined as

ε=((a·η₁)/c−(a−b·(1−η₂)))/b (III),

0.6≤c<1 (IV),

preferably 0.7≤c<1 (IVa),

more preferably 0.7≤c≤0.9 (IVb),

particular preferably 0.75≤c≤0.85 (IVc),

where
η₁ is the initial coulombic efficiency of the cathode, and
c is the depth of discharge (DoD) of the anode.

In particular, c=(b·(1−η₂)−a·(1−η₁))/b, when c=1.

In accordance with another embodiment of the method according to the present invention, the electrolyte comprises one or more fluorinated carbonate compounds, preferably fluorinated cyclic or acyclic carbonate compounds, as a nonaqueous organic solvent.

In accordance with another embodiment of the method according to the present invention, the fluorinated carbonate compounds can be selected from the group consisting of fluorinated ethylene carbonate, fluorinated propylene carbonate, fluorinated dimethyl carbonate, fluorinated methyl ethyl carbonate, and fluorinated diethyl carbonate, in which the “fluorinated” carbonate compounds can be understood as “monofluorinated”, “difluorinated”, “trifluorinated”, “tetrafluorinated”, and “perfluorinated” carbonate compounds.

In accordance with another embodiment of the method according to the present invention, the fluorinated carbonate compounds can be selected from the group consisting of monofluoroethylene carbonate, 4,4-difluoro ethylene carbonate, 4,5-difluoro ethylene carbonate, 4,4,5-trifluoroethylene carbonate, 4,4,5,5-tetrafluoroethylene carbonate, 4-fluoro-4-methyl ethylene carbonate, 4,5-difluoro-4-methyl ethylene carbonate, 4-fluoro-5-methyl ethylene carbonate, 4,4-difluoro-5-methyl ethylene carbonate, 4-(fluoromethyl)-ethylene carbonate, 4-(difluoromethyl)-ethylene carbonate, 4-(trifluoromethyl)-ethylene carbonate, 4-(fluoromethyl)-4-fluoro ethylene carbonate, 4-(fluoromethyl)-5-fluoro ethylene carbonate, 4,4,5-trifluoro-5-methyl ethylene carbonate, 4-fluoro-4,5-dimethyl ethylene carbonate, 4,5-difluoro-4,5-dimethyl ethylene carbonate, and 4,4-difluoro-5,5-dimethyl ethylene carbonate.

In accordance with another embodiment of the method according to the present invention, the content of the fluorinated carbonate compounds can be 10˜100 vol. %, preferably 30˜100 vol. %, more preferably 50˜100 vol. %, particular preferably 80˜100 vol. %, based on the total nonaqueous organic solvent.

In accordance with another embodiment of the method according to the present invention, the active material of the anode can be selected from the group consisting of carbon, silicon, silicon intermetallic compound, silicon oxide, silicon alloy and mixtures thereof.

In accordance with another embodiment of the method according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

### EXAMPLES

The following non-limiting examples describe preparation of the electrode comprising Si-based composite according to the present invention and compare the performance of the obtained electrodes with those prepared not according to the present invention.

The following Examples illustrate various features and characteristics of the present invention, whose scope however is not to be construed as limited thereto:

### Example 1—Preparation of Electrode Comprising Si-Based Composite According to the Present Invention

Preparation of Si-Based Composite and the Electrode

Firstly, 0.08 g nano silicon particles (50-200 nm) (Alfa-Aesar) were dispersed in 80 ml Tris-HCl (10 mM, pH=8.5) buffer solution containing 0.08 g dopamine hydrochloride (Alfa-Aesar) and then stirred for 2 h, during which period, dopamine is polymerized in situ on the surface of the silicon-based material by air oxidization. Then silicon particles coated by polydopamine were collected by centrifugation and washed by water and vacuum dried for future use. The thickness of PD coating was 1-2 nm according to TEM images. Then the particles prepared above were mixed with Super P (40 nm, Timical) and PAA (Mv˜450 000, Aldrich) in an 8:1:1 weight ratio in water. After stirred for 5 h, during which period, the polydopamine is crosslinked to PAA, the slurry was coated onto a Cu foil current then further dried at 70° C. in vacuum for 8 h. The loading of active material is ca. 0.5 mg/cm². The foil was cut to Φ12 mm sheets to assemble cells.

### Comparative Example 1a

Comparative Example 1a was prepared similar to Example 1, except that pristine nano Si particles were used to prepare the electrode.

### Comparative Example 1b

Comparative Example 1b was prepared similar to Example 1, except that the nano silicon particles was changed to 0.4 g, dopamine hydrochloride was changed to 0.2 g, and Tris-HCl buffer solution was changed to 100 ml respectively. The stirring lasted for 6 h. The thickness of PD coating was about 3 nm according to TEM images. Then the particles prepared above were used to prepared electrode similar to Example 1.

### Example 2—Preparation of Electrode Comprising Si-Based Composite According to the Present Invention

Except that the loading of active material in electrode was changed from 0.5 mg/cm² to ca. 2.0 mg/cm², Example 2 was prepared similar to Example 1.

### Comparative Example 2

Comparative Example 2 was prepared similar to Comparative Example 1a, except that the loading of active material in electrode was changed from 0.5 mg/cm² to ca. 2.0 mg/cm².

Cells Assembling and Electrochemical Test

The electrochemical performances of the above prepared electrodes were respectively tested using two-electrode coin-type cells. The CR2016 coin cells were assembled in an argon-filled glove box (MB-10 compact, MBraun) using 1 M LiPF₆/EC+DMC (1:1 by volume, ethylene carbonate (EC), dimethyl carbonate (DMC)) as electrolyte, including 10% Fluoroethylene carbonate (FEC), ENTEK ET20-26 as separator, and pure lithium foil as counter electrode. The cycling performances were evaluated on a LAND battery test system (Wuhan Kingnuo Electronics Co., Ltd., China) at 25° C. constant current densities. The cut-off voltage was 0.01 V versus Li/Li⁺ for discharge (Li insertion) and 1.2 V versus Li/Li⁺ for charge (Li extraction). The specific capacity was calculated on the basis of the weight of active materials.

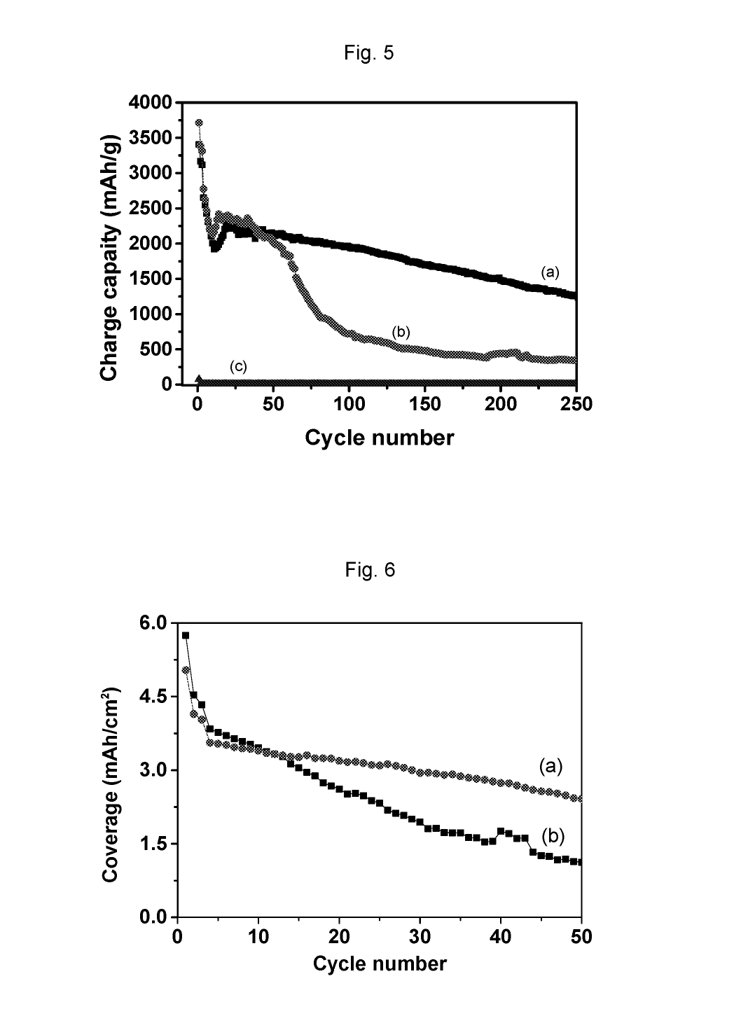

FIG. 5 shows the cycling performance of the cross-linked electrodes (Si@PD+PAA) in Example 1 and in Comparative Example 1b and conventional electrode (Si+PAA) in Comparative Example 1a with a low mass loading. The coin cell was discharged at 0.1 Ag⁻¹ for the first cycle and 0.3 Ag⁻¹ in the next two cycles and 1.5 Ag⁻¹ for the following cycles between 0.01 and 1.2 V vs Li/Li⁺. The mass loading of active materials (Si and Si@PD) in every electrode is ca. 0.5 mg/cm².

From FIG. 5, it can be seen that the cross-linked electrode in Example 1 (curve (a)) shows much better cycle performance than conventional electrode with only PAA binder (curve (b)). At a high current density of 1.5 Ag⁻¹, the conventional electrode with PAA binder shows fast capacity decay after 50 cycles and only 549 mAh/g capacity is remained after 150 cycles. While cross-linked electrode achieves specific capacity of 2128 and 1715 mAh g⁻¹ after 100 and 150 cycles, respectively. This improvement could be attributed to the three-dimensional binding network and enhanced interaction by stronger hydrogen bond. However, because of low electronic conductivity of PD, if the PD coating layer is too thick, for example 3 nm in Comparative Example 1b, the PD layer will inhibit the electron transfer. Therefore, Comparative Example 1b shows quite low capacity (curve (c)).

FIG. 6 further shows the cycling performance of the cross-linked electrode (Si@PD+PAA) in Example 2 and conventional electrode (Si+PAA) in Comparative Example 2 with high mass loading. The coin cell was discharged at 0.1 Ag⁻¹ for the first cycle and 0.3 Ag⁻¹ in the next two cycles and 0.5 Ag⁻¹ for the following cycles between 0.01 and 1.2 V vs Li/Li⁺. The mass loading of active materials (Si and Si@PD) in every electrode is ca. 2.0 mg/cm².

From FIG. 6, comparing with conventional electrodes with PAA as binders, the cross-linked electrode still gets obvious advantages with such high active material loading (2.0 mg/cm²). After 50 cycles, the specific capacity of cross-linked electrode is 1254 mAh g⁻¹ corresponding to 2.4 mAh/cm², while the conventional electrode only remains 1.1 mAh/cm².

The present invention has greatly improved electrochemical performances, especially cycle performance via wrapping the silicon particles with PD before making the electrode.

### Examples 3 to 7—Preparation of Electrodes Comprising Si-Based Composite According to the Present Invention

### Example 3

Firstly, 0.24 g nano silicon particles (Alfa Aesar, 50-200 nm) were mixed with 0.03 g Super P (40 nm, Timical) and 0.03 g PAA (Mv˜450 000, Aldrich) in an 8:1:1 weight ratio in water. After stirred for 1 h, 0.024 mg (0.01% based on the weight of nano silicon particles) of silane coupling agent γ-aminopropyl triethoxysilane (KH550) was added into the slurry. After stirring for another 4 h, the slurry was coated onto a Cu foil current then further dried at 70° C. in vacuum for 8 h. The loading of active material is ca. 0.5 mg/cm². The foil was cut to Φ12 mm sheets to assemble cells.

Example 4 was prepared similar to Example 3, except that 0.24 mg KH550 was added into slurry, corresponding to 0.1 wt % ratio of KH550 to Si.

Example 5 was prepared similar to Example 3, except that 1.2 mg KH550 was added into slurry, corresponding to 0.5 wt % ratio of KH550 to Si.

Example 6 was prepared similar to example 3, except that 2.4 mg KH550 was added into slurry, corresponding to 1 wt % ratio of KH550 to Si.

Example 7 was prepared similar to Example 4, except that the loading of active material in electrode is ca. 2.0 mg/cm².

Comparative Examples 3 and 4—Preparation of electrode comprising Si-based composite not according to the present invention

Comparative Example 3 was prepared similar to Example 3, except that 7.2 mg KH550 was added into slurry, corresponding to 3 wt % ratio of KH550 to Si. An excess amount of KH550 would impair the electronic conductivity and deteriorate the cell performance.

### Comparative Example 4

The process used in Comparative Example 4 is different from the inventive process. In Comparative Example 4, the process comprises firstly coating Si by silane coupling agent and then preparing the slurry. In contrast, the inventive process comprises directly adding silane coupling agent during the slurry preparation.

Specifically, in Comparative Example 4, 0.5 g nano silicon particles (50-200 nm) (Alfa-Aesar) and 0.005 g (corresponding to 1 wt %) silane coupling agent KH550 were firstly dispersed in 25 ml water and then stirred for 6 h. Then silicon particles coated by silane coupling agent were collected by centrifugation and washed by water for future use. Then the KH550 modified nano Si particles were used to prepared electrode similar to Example 3.

Cells Assembling and Electrochemical Test

The electrochemical performances of the as-prepared anodes were tested using two-electrode coin-type cells. The CR2016 coin cells were assembled in an argon-filled glove box (MB-10 compact, MBraun) using 1 M LiPF₆/EC+DMC (1:1 by volume, ethylene carbonate (EC), dimethyl carbonate (DMC)) as electrolyte, including 10% Fluoroethylene carbonate (FEC), ENTEK ET20-26 as separator, and pure lithium foil as counter electrode. The cycling performances were evaluated on a LAND battery test system (Wuhan Kingnuo Electronics Co., Ltd., China) at 25° C. constant current densities. The cut-off voltage was 0.01 V versus Li/Li⁺ for discharge (Li insertion) and 1.2 V versus Li/Li⁺ for charge (Li extraction). The specific capacity was calculated on the basis of the weight of active materials.

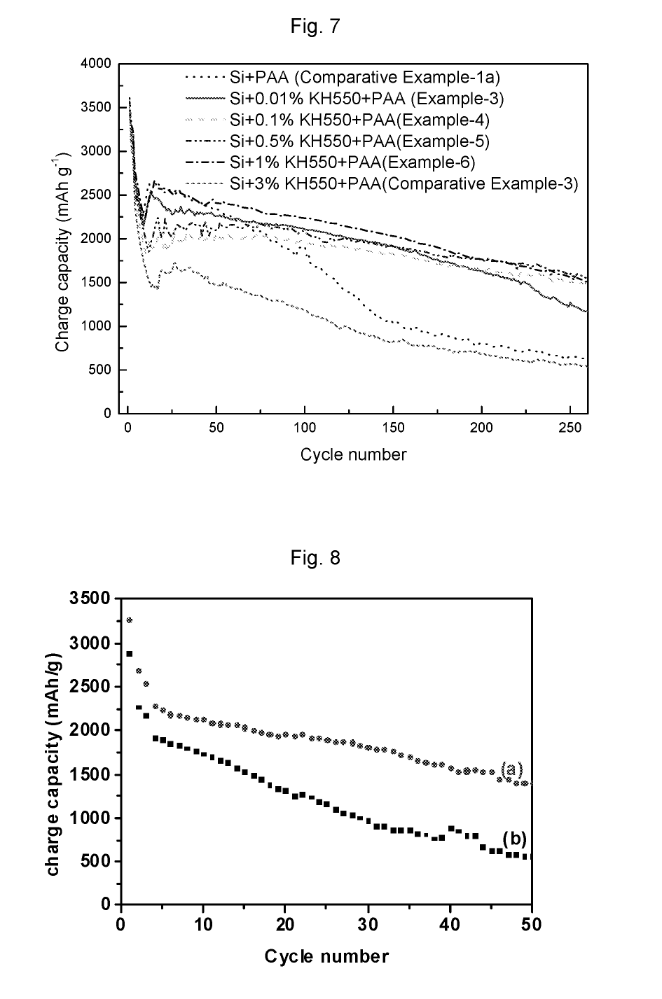

FIG. 7 is a plot showing the cycling performance of the Si electrodes without KH550 (Si-PAA) prepared in Comparative Example 1a and modified Si electrode (Si-KH550-PAA) prepared in Examples 3-6 and Comparative Example 3 with a low mass loading. The coin cell was charge/discharged at 0.1 Ag⁻¹ for the first cycle and 0.3 Ag⁻¹ in the next two cycles and 1.5 Ag⁻¹ for the following cycles between 0.01 and 1.2 V vs Li/Li⁺. The mass loading of active materials (Si) in every electrode is ca. 0.5 mg/cm².

As shown in FIG. 7, the modified electrodes Si-KH550-PAA (with 0.01 wt %, 0.1 wt %, 0.5 wt % and 1 wt % of KH550) show much better cycling performance than both Si electrode without KH550 in Comparative Example 1a and the modified electrode Si-KH550-PAA having a high amount of KH550 (with 3.0 wt % KH550) in Comparative Example 3. And even at such a high current density (1.5 Ag⁻¹), the modified electrodes Si-KH550-PAA (with 0.01 wt %, 0.1 wt %, 0.5 wt % and 1 wt % of KH550) achieve specific capacity of more than 1690 mAh g⁻¹ after 180 cycles, while the capacity of Si-PAA reduces to less than 900 mAh g⁻¹ and the capacity of Si-KH550-PAA (with 3.0 wt % KH550) reduces to less than 750 mAh g⁻¹ under the same conditions. This improvement can be attributed to the formed strong three-dimensional binding network.

FIG. 8 shows the cycling performance of the modified Si electrode (Si-KH550-PAA) in Example 7 and Si electrode without KH550 (Si-PAA) in Comparative Example 1a with high loading. The coin cell was charge/discharged at 0.1 Ag⁻¹ for the first cycle and 0.3 Ag⁻¹ in the next two cycles and 0.5 Ag⁻¹ for the following cycles between 0.01 and 1.2 V vs Li/Li⁺. The mass loading of active materials (Si) in every electrode is ca. 2.0 mg/cm².

Since the high loading is meaningful for the commercial demand of high energy density, the effects of the present invention in high loading electrodes were investigated. As shown in FIG. 8, comparing with Si-PAA, the modified electrodes Si-KH550-PAA gets obvious advantages with such high active material loading (2.0 mg/cm²). Si-KH550-PAA shows higher capacity (3276 mAh/g, corresponding to 6.6 mAh/cm²) than Si-PAA (2886 mAh/g, corresponding to 5.7 mAh/cm²). After 50 cycles, the Si-KH550-PAA remains 61% capacity, while the capacity of Si-PAA reduces to 29%.

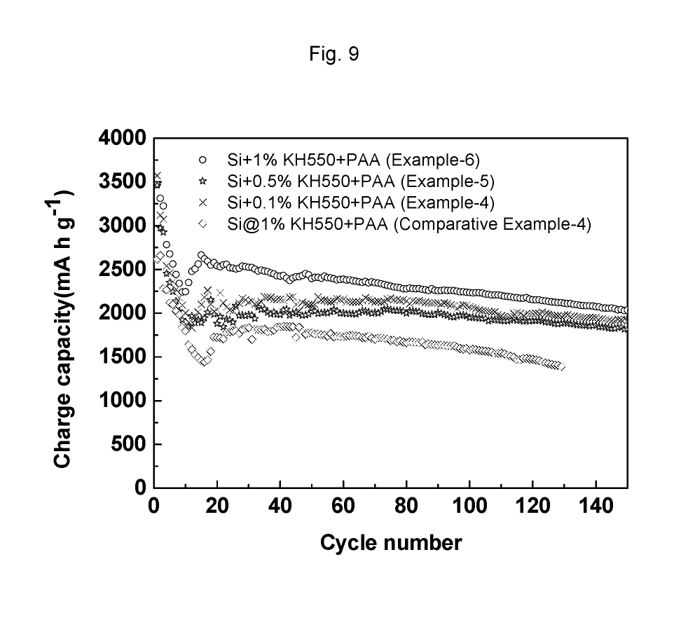

FIG. 9 is a plot showing the cycling performance of the Si electrode prepared in Example 4-6 and Comparative Example 4. In other words, FIG. 9 compared the electrochemical performance of electrodes prepared from two methods: 1) the method of the present invention, that is, directly adding KH550 during slurry preparation; 2) the method in Comparative Example 4, that is, pre-treating Si with KH550 and then using the KH550 modified Si to prepare slurry. The results show that the electrodes from directly adding KH550 have better cycling performance, especially after 40 cycles. After 100 cycles, the capacity of electrodes from the inventive method 1) remains ca. 2000 mAh/g, while the electrode from method 2) decrease to 1576 mAh/g.

Not binding to the theory, it is believed that directly adding KH550 during slurry preparation, the hydrolysis ends of one KH 550 molecule, in addition to connecting to the Si surface, also connect to hydrolysis ends of other KH550 molecule (KH550-KH550), after non-hydrolysis ends connect to PAA, highly cross-linked 3D binding network is formed. (PAA-KH550-KH550-PAA). Therefore, the binding network is more stable. While by pre-treat Si by KH550, such KH550-KH550 small molecules are removed during washing, thus generate less cross-linked point afterwards. Therefore, the cycling performance becomes poorer.

Therefore, the present invention has greatly improved electrochemical performances, especially cycle performance by forming covalent bond connected three dimensional binding network via adding silane coupling agent into the slurry during stirring.

### Examples P1 for Prelithiation

Active material of the cathode: NCM-111 from BASF, and HE-NCM prepared according to the method as described in WO 2013/097186 A1;
Active material of the anode: a mixture (1:1 by weight) of silicon nanoparticle with a diameter of 50 nm from Alfa Aesar and graphite from Shenzhen Kejingstar Technology Ltd.;
Carbon additives: flake graphite KS6L and Super P Carbon Black C65 from Timcal; Binder: PAA, Mv=450,000, from Sigma Aldrich;
Electrolyte: 1M LiPF₆/EC (ethylene carbonate)+DMC (dimethyl carbonate) (1:1 by volume);
Separator: PP/PE/PP membrane Celgard 2325.

### Example P1-E1

At first anode/Li half cells were assembled in form of 2016 coin cell in an Argon-filled glove box (MB-10 compact, MBraun), wherein lithium metal was used as the counter electrode. The assembled anode/Li half cells were discharged to the designed prelithiation degree E as given in Table P1-E1, so as to put a certain amount of Li⁺ ions in the anode, i.e., the prelithiation of the anode. Then the half cells were disassembled. The prelithiated anode and NCM-111 cathode were assembled to obtain 2032 coin full cells. The cycling performances of the full cells were evaluated at 25° C. on an Arbin battery test system at 0.1 C for formation and at 1 C for cycling.

TABLE P1-E1

| Group | a | η₁ | b | η₂ | ε | c | x | η_{F} | Life |
|---|---|---|---|---|---|---|---|---|---|
| G0 | 2.30 | 90% | 2.49 | 87% | 0 | 1.00 | 1.08 | 83% | 339 |
| G1 | 2.30 | 90% | 2.68 | 87% | 5.6% | 0.99 | 1.10 | 86% | 353 |
| G2 | 2.30 | 90% | 3.14 | 87% | 19.5% | 0.83 | 1.10 | 89% | 616 |
| G3 | 2.30 | 90% | 3.34 | 87% | 24.3% | 0.77 | 1.10 | 88% | 904 |
| G4 | 2.30 | 90% | 3.86 | 87% | 34.6% | 0.66 | 1.10 | 89% | 1500 |

a initial delithiation capacity of the cathode [mAh/cm²];
η₁ initial Coulombic efficency of the cathode;
b initial lithiation capacity of the anode [mAh/cm²];
η₂ initial Coulombic efficency of the anode;
ε prelithiation degree of the anode;
c depth of discharge of the anode;
x = b · (1 − ε)/a, balance of the anode and cathode capacities after prelithiation;
η_{F} initial Coulombic efficiency of the full cell;
Life cycle life of the full cell (80% capacity retention).

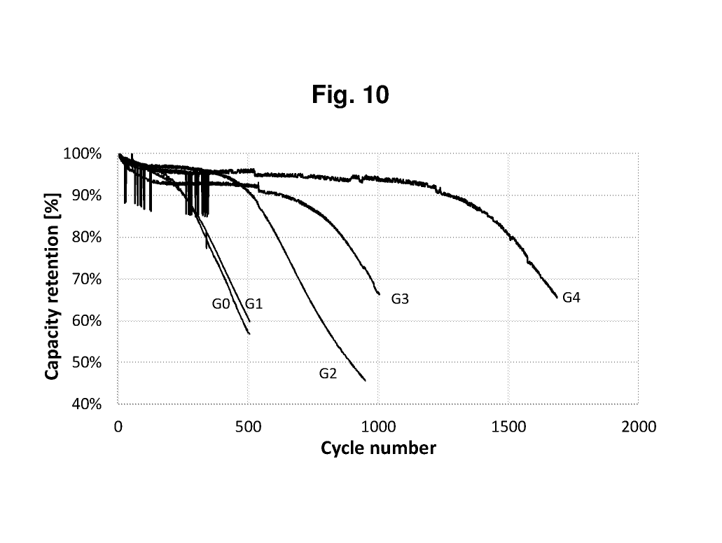

FIG. 10 shows the cycling performances of the full cells of Groups G0, G1, G2, G3, and G4 of Example P1-E1.

In case of Group G0 with a prelithiation degree E=0, the capacity of the full cell was decreased to 80% after 339 cycles.

In case of Group G1 with a prelithiation degree of 5.6%, the prelithiation amount was only enough to compensate the irreversible Li loss difference between the cathode and the anode. Therefore, the initial Coulombic efficiency was increased from 83% to 86%, while no obvious improvement in cycling performance was observed.

In case of Group G2 with a prelithiation degree increased to 19.5%, the prelithiation amount was not only enough to compensate the irreversible Li loss difference between the cathode and the anode, but also extra amount of Li was reserved in the anode to compensate the Li loss during cycling. Hence, the cycle life was greatly improved to 616 cycles.

In case of Groups G3 and G4 with further increased prelithiation degrees, more and more Li was reserved in the anode, so better and better cycling performances were obtained.

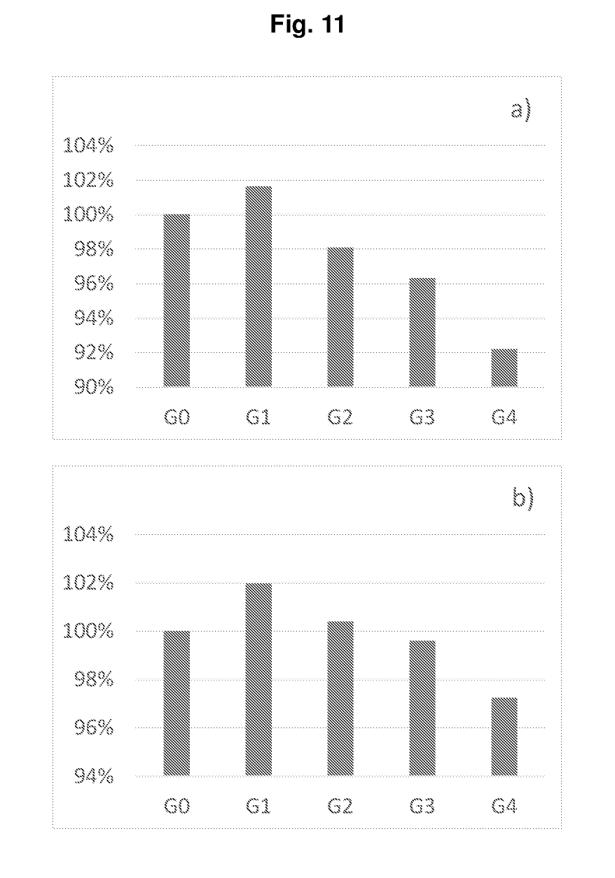

FIG. 11 shows a) the volumetric energy densities and b) the gravimetric energy densities of the full cells of Groups G0, G1, G2, G3, and G4 in Example P1-E1. Compared with non-prelithiation (G0), Group G1 with 5.6% prelithiation degree shows a higher energy density due to the higher capacity. In case of the further increased prelithiation degree for a better cycling performance, the energy density decreases to some extend but still has more than 90% energy density of G0 when prelithiation degree reaches 34.6% in G4.

### Example P1-E2

Example P1-E2 was carried out similar to Example P1-E1, except that HE-NCM was used as the cathode active material and the corresponding parameters were given in Table P1-E2.

TABLE P1-E2

| Group | a | η₁ | b | η₂ | ε | c | x | η_{F} | Life |
|---|---|---|---|---|---|---|---|---|---|
| G0 | 3.04 | 96% | 3.25 | 87% | 0 | 1.00 | 1.07 | 85% | 136 |
| G1 | 3.04 | 96% | 4.09 | 87% | 18.3% | 0.90 | 1.10 | 94% | 231 |
| G2 | 3.04 | 96% | 4.46 | 87% | 26.3% | 0.80 | 1.08 | 95% | 316 |

a initial delithiation capacity of the cathode [mAh/cm²];
η₁ initial Coulombic efficency of the cathode;
b initial lithiation capacity of the anode [mAh/cm²];
η₂ initial Coulombic efficency of the anode;
ε prelithiation degree of the anode;
c depth of discharge of the anode;
x = b · (1 − ε)/a, balance of the anode and cathode capacities after prelithiation;
η_{F} initial Coulombic efficiency of the full cell;
Life cycle life of the full cell (80% capacity retention).

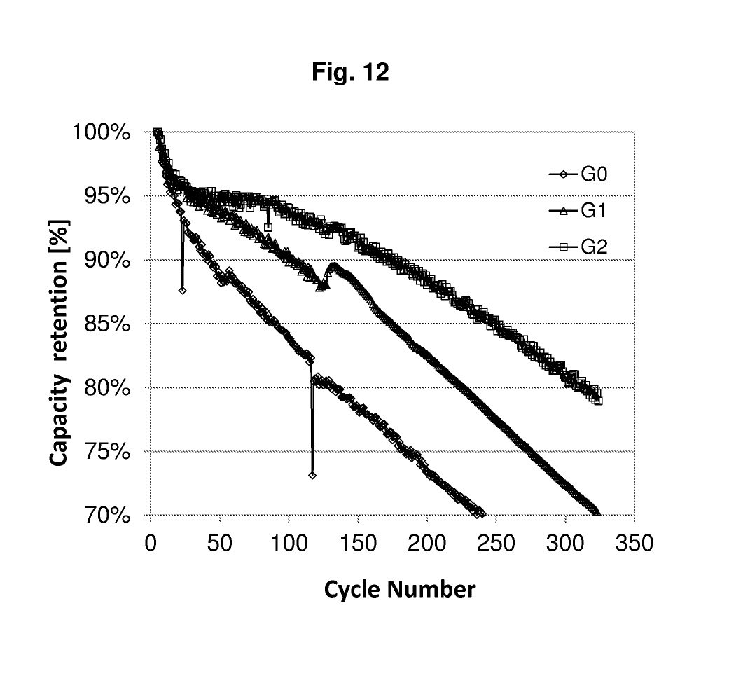

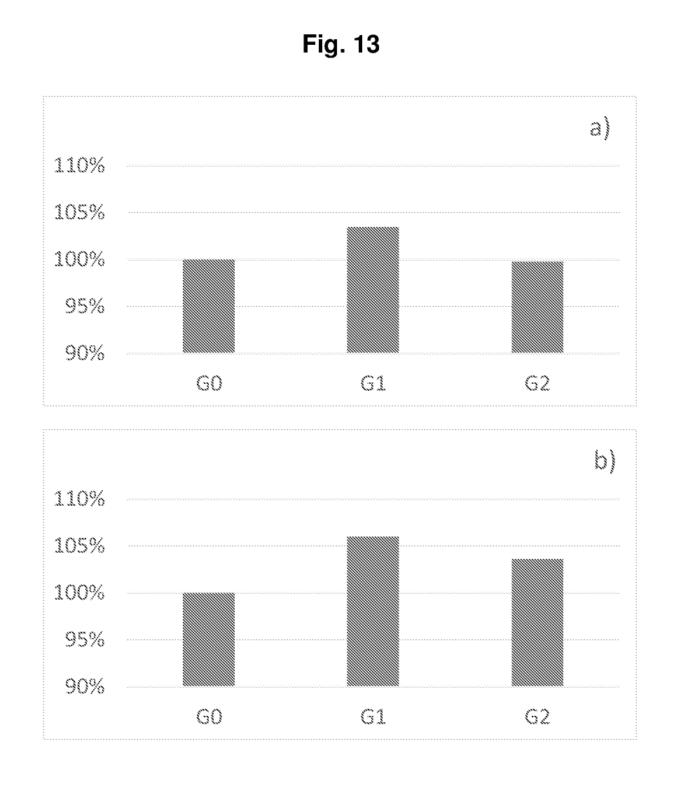

FIG. 12 shows the cycling performances of the full cells of Groups G0, G1, and G2 of Example P1-E2. FIG. 13 shows a) the volumetric energy densities and b) the gravimetric energy densities of the full cells of Groups G0, G1, and G2 of Example P1-E2. It can been seen from Table P1-E2 that the initial Coulombic efficiencies of the full cells were increased from 85% to 95% in case of the prelithiation. Although larger anodes were used for prelithiation, the energy density did not decrease, or even a higher energy density was reached, compared with non-prelithiation in G0. Moreover, the cycling performances were greatly improved, because the Li loss during cycling was compensated by the reserved Li.

### Example P1-E3

Example P1-E3 was carried out similar to Example P1-E1, except that pouch cells were assembled instead of coin cells, and the corresponding prelithiation degrees ε of the anode were a) 0 and b) 22%.

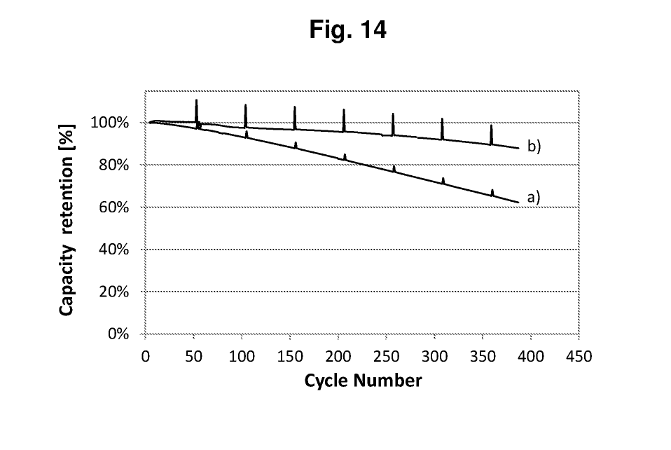

FIG. 14 shows the cycling performances of the full cells of Example P1-E3 with the prelithiation degrees ε of a) 0 and b) 22%. It can been seen that the cycling performance was much improved in case of the prelithiation.

### Examples P2 for Prelithiation

Size of the pouch cell: 46 mm×68 mm (cathode); 48 mm×71 mm (anode);
Cathode: 96.5 wt. % of NCM-111 from BASF, 2 wt. % of PVDF Solef 5130 from Sovey, 1 wt. % of Super P Carbon Black C65 from Timcal, 0.5 wt. % of conductive graphite KS6L from Timcal;
Anode: 40 wt. % of Silicon from Alfa Aesar, 40 wt. % of graphite from BTR, 10 wt. % of NaPAA, 8 wt. % of conductive graphite KS6L from Timcal, 2 wt. % of Super P Carbon Black C65 from Timcal;
Electrolyte: 1M LiPF₆/EC+DMC (1:1 by volume, ethylene carbonate (EC), dimethyl carbonate (DMC), including 30 vol. % of fluoroethylene carbonate (FEC), based on the total nonaqueous organic solvent);
Separator: PP/PE/PP membrane Celgard 2325.

### Comparative Example P2-CE1

A pouch cell was assembled with a cathode initial capacity of 3.83 mAh/cm² and an anode initial capacity of 4.36 mAh/cm² in an Argon-filled glove box (MB-10 compact, MBraun). The cycling performance was evaluated at 25° C. on an Arbin battery test system at 0.1 C for formation and at 1 C for cycling, wherein the cell was charged to the nominal charge cut off voltage 4.2 V, and discharged to the nominal discharge cut off voltage 2.5 V or to a cut off capacity of 3.1 mAh/cm². The calculated prelithiation degree ε of the anode was 0.

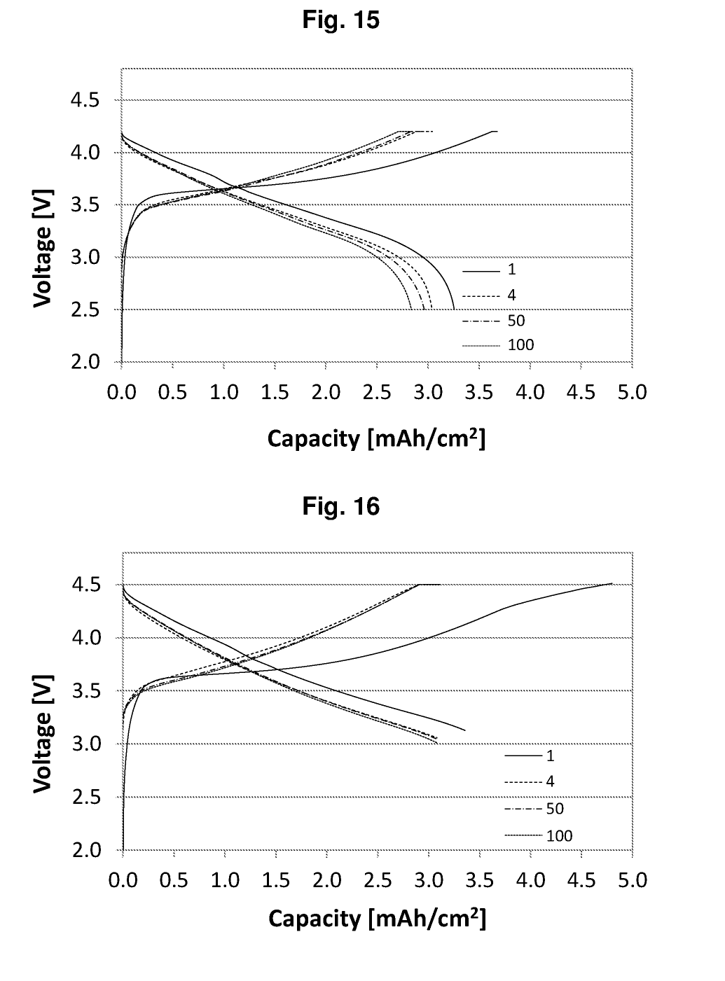

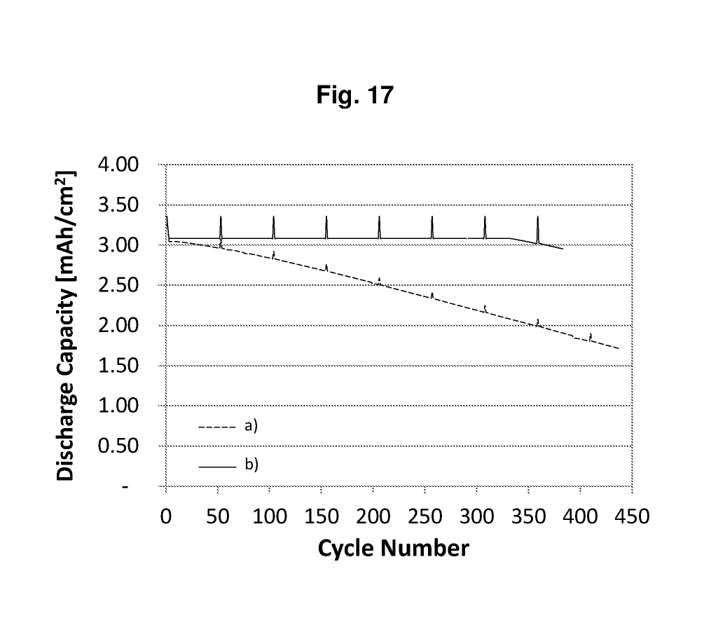

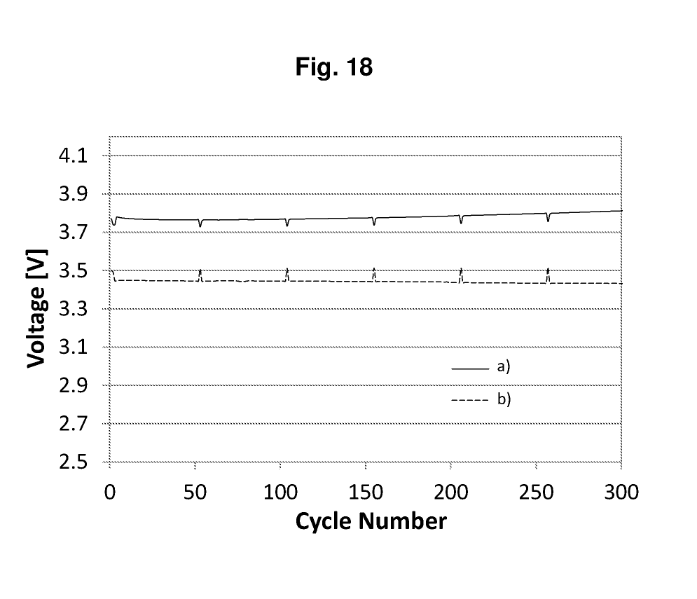

FIG. 15 shows the discharge/charge curve of the cell of Comparative Example P2-CE1, wherein “1”, “4”, “50” and “100” stand for the 1^{st}, 4^{th}, 50^{th} and 100^{th} cycle respectively. FIG. 17 shows the cycling performances of the cells of a) Comparative Example P2-CE1 (dashed line). FIG. 18 shows the average charge voltage a) and the average discharge voltage b) of the cell of Comparative Example P2-CE1.

### Example P2-E1

A pouch cell was assembled with a cathode initial capacity of 3.73 mAh/cm² and an anode initial capacity of 5.17 mAh/cm² in an Argon-filled glove box (MB-10 compact, MBraun). The cycling performance was evaluated at 25° C. on an Arbin battery test system at 0.1 C for formation and at 1 C for cycling, wherein the cell was charged to a cut off voltage of 4.5 V, which was 0.3 V greater than the nominal charge cut off voltage, and discharged to the nominal discharge cut off voltage 2.5 V or to a cut off capacity of 3.1 mAh/cm². The calculated prelithiation degree ε of the anode was 21%.

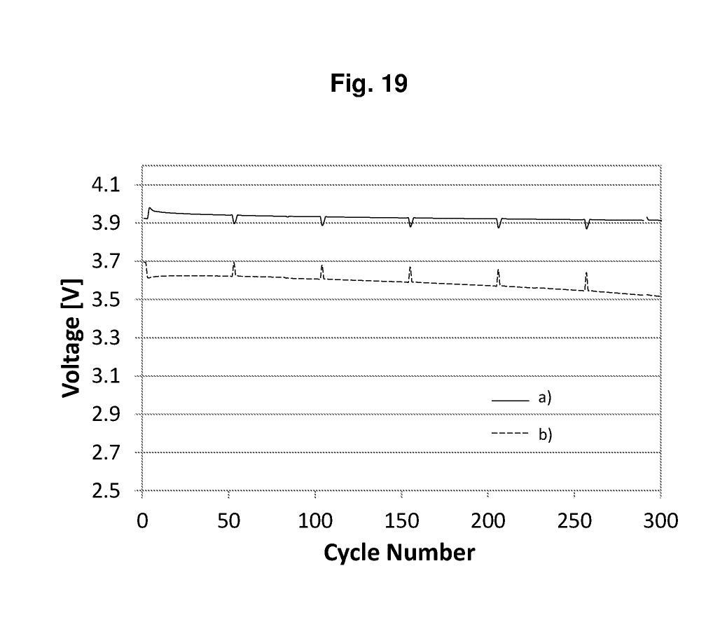

FIG. 16 shows the discharge/charge curve of the cell of Example P2-E1, wherein “1”, “4”, “50” and “100” stand for the 1^{st}, 4^{th}, 50^{th} and 100^{th} cycle respectively. FIG. 17 shows the cycling performances of the cells of b) Example P2-E1 (solid line). FIG. 19 shows the average charge voltage a) and the average discharge voltage b) of the cell of Example P2-E1.

While certain embodiments have been described, these embodiments have been presented by way of example only, and are not intended to limit the scope of the inventions. The attached claims and their equivalents are intended to cover all the modifications, substitutions and changes as would fall within the scope and spirit of the invention.

1. A silicon-based composite with three dimensional binding network and enhanced interaction between binder and silicon-based material, which comprises silicon-based material, treatment material, a binder which contains carboxyl groups, and conductive carbon, wherein the treatment material is selected from the group consisting of polydopamine and silane coupling agent with amine and/or imine groups.

2. The silicon-based composite according to claim 1, wherein the treatment material is polydopamine, and the average thickness of the polydopamine coating on said silicon-based material is in the range from 0.5 to 2.5 nm, preferably from 1 to 2 nm.

3. The silicon-based composite according to claim 1, wherein the treatment material is silane coupling agent with amine and/or imine groups, and the amount of the silane coupling agent is from 0.01-2.5 wt %, preferably 0.05-2.0 wt %, more preferably 0.1-2.0 wt %, and much more preferably 0.1-1.0%, based on the weight of the silicon-based material.

4. The silicon-based composite according to claim 1, wherein the binder which contains carboxyl groups are selected from the group consisting of polyacrylic acid, carboxymethyl cellulose, sodium alginate, copolymers thereof and combinations thereof.

5. The silicon-based composite according to claim 1, wherein the silane coupling agent with amine and/or imine groups are one or more selected from the group consisting of γ-aminopropyl methyl diethoxysilane, γ-aminopropyl methyl dimethoxysilane, γ-aminopropyl triethoxysilane, γ-aminopropyl trimethoxysilane, N-(β-aminoethyl)-γ-aminopropyl trimethoxy silane, N-(β-aminoethyl)-γ-aminopropyl triethoxy silane, N-(β-aminoethyl)-γ-aminopropyl methyl dimethoxysilane, N,N-(aminopropyltriethoxy) silane, γ-trimethoxysilyl propyl diethylenetriamine, γ-divinyltriamine propymethyldimethoxyl silane, bis-γ-trimethoxysilypropyl amine, aminoneohexyltromethoxysilane, and aminoneohexylmethydimethoxysilane.

6. An electrode material, comprising the silicon-based composite of claim 1.

7. A lithium-ion battery, comprising the silicon-based composite of claim 1.

8. A process for preparing the silicon-based composite of claim 1, comprising the steps of:
(1) dispersing silicon-based material in a buffer solution containing dopamine,
(2) initiating in-situ polymerization of dopamine on the surface of the silicon-based material by air oxidization, and
(3) collecting the silicon-based material coated by polydopamine, and
(4) crosslinking the polydopamine to a binder which contains carboxyl groups.

9. A process for preparing the silicon-based composite of claim 1, comprising adding silane coupling agent with amine and/or imine groups into a slurry including silicon-based material, a binder which contains carboxyl groups and conductive carbon during stirring.

10. A lithium-ion battery comprising a cathode, an electrolyte, and an anode, wherein the electrode material of the anode comprises the silicon-based composite of claim 1; and the initial surface capacity a of the cathode and the initial surface capacity b of the anode satisfy the relation formulae
1<(b·(1−ε)/a)≤1.2 (I),
preferably 1.05≤(b·(1−ε)/a)≤1.15 (Ia),
more preferably 1.08≤(b·(1−ε)/a)≤1.12 (Ib),
0<ε≤((a·η₁)/0.6−(a−b·(1−η₂)))/b (II),
where
ε is the prelithiation degree of the anode,
η₁ is the initial coulombic efficiency of the cathode, and
η₂ is the initial coulombic efficiency of the anode.

11. The lithium-ion battery of claim 10, characterized in that
ε=((a·η₁)/c−(a−b·(1−η₂)))/b (III),
0.6≤c<1 (IV),
preferably 0.7≤c<1 (IVa),
more preferably 0.7≤c≤0.9 (IVb),
particular preferably 0.75≤c≤0.85 (IVc),
where
c is the depth of discharge of the anode.

12. A method for producing a lithium-ion battery comprising a cathode, an electrolyte, and an anode, wherein the silicon-based composite is prepared by the process of claim 8; and said method includes the following steps:
1) prelithiating the active material of the anode or the anode to a prelithiation degree ε, and
2) assembling the anode and the cathode to obtain said lithium-ion battery,
characterized in that the initial surface capacity a of the cathode, the initial surface capacity b of the anode, and the prelithiation degree ε satisfy the relation formulae
1<(b·(1−ε)/a)≤1.2 (I),
preferably 1.05≤(b·(1−ε)/a)≤1.15 (Ia),
more preferably 1.08≤(b·(1−ε)/a)≤1.12 (Ib),
0<ε≤((a·η₁)/0.6−(a−b·(1−η₂)))/b (II),
where
ε is the prelithiation degree of the anode,
η₁ is the initial coulombic efficiency of the cathode, and
η₂ is the initial coulombic efficiency of the anode.

13. The method of claim 12, characterized in that
ε=((a·η₁)/c−(a−b·(1−η₂)))/b (III),
0.6≤c<1 (IV),
preferably 0.7≤c<1 (IVa),
more preferably 0.7≤c≤0.9 (IVb),
particular preferably 0.75≤c≤0.85 (IVc),
where
c is the depth of discharge of the anode.

14-20. (canceled)

21. A method for producing a lithium-ion battery comprising a cathode, an electrolyte, and an anode, wherein the silicon-based composite is prepared by the process of claim 8; and said method includes the following steps:
1) assembling the anode and the cathode to obtain said lithium-ion battery, and
2) subjecting said lithium-ion battery to a formation process, wherein said formation process includes an initial formation cycle comprising the following steps:
a) charging the battery to a cut off voltage V_{off} which is greater than the nominal charge cut off voltage of the battery, preferably up to 0.8 V greater than the nominal charge cut off voltage of the battery, more preferably 0.1˜0.5 V greater than the nominal charge cut off voltage of the battery, particular preferably 0.2˜0.4 V greater than the nominal charge cut off voltage of the battery, especially preferably about 0.3 V greater than the nominal charge cut off voltage of the battery, and
b) discharging the battery to the nominal discharge cut off voltage of the battery.

22. The method of claim 21, characterized in that the relative increment r of the initial surface capacity of the cathode over the nominal initial surface capacity a of the cathode and the cut off voltage V_{off} satisfy the following linear equation with a tolerance of ±10%
r=0.75V_{off}−3.134 (V).

23. The method of claim 21, characterized in that the relative increment r of the initial surface capacity of the cathode over the nominal initial surface capacity a of the cathode and the cut off voltage V_{off} satisfy the following quadratic equation with a tolerance of ±10%
r=−0.7857V_{off}²+7.6643V_{off}−18.33 (Va).

24. The method of claim 21, characterized in that the nominal initial surface capacity a of the cathode and the initial surface capacity b of the anode satisfy the relation formulae
1<b·η₂/(a·(1+r)−b·(1−η₂))−ε≤1.2 (I′),
preferably 1.05≤b·η₂/(a*(1+r)−b·(1−η₂))−ε≤1.15 (Ia′),
more preferably 1.08≤b·η₂/(a·(1+r)−b*(1−η₂))−ε≤1.12 (Ib′),
0<ε≤((a·η₁)/0.6−(a−b·(1−η₂)))/b (II),
where
ε is the prelithiation degree of the anode, and
η₂ is the initial coulombic efficiency of the anode.

25. The method of claim 21, characterized in that
ε=((a·η₁)/c−(a−b·(1−η₂)))/b (III),
0.6≤c<1 (IV),
preferably 0.7≤c<1 (IVa),
more preferably 0.7≤c≤0.9 (IVb),
particular preferably 0.75≤c≤0.85 (IVc),
where
η₁ is the initial coulombic efficiency of the cathode, and
c is the depth of discharge of the anode.

26. The method of claim 21, characterized in that the electrolyte comprises one or more fluorinated carbonate compounds, preferably fluorinated cyclic or acyclic carbonate compounds, as a nonaqueous organic solvent.
